(19) United States
(12) Patent Application Publication
(10) Pub. No.: US 2004/0190860 A1
(43) Pub. Date: Sep. 30, 2004

(54) Equipment for digital video disc processing information on digital video disc using prescribed information serving as key, and method and apparatus for recording prescribed information

(76) Inventor: Fusao Ishiguchi, Osaka (JP)

Correspondence Address: OSHA & MAY L.L.P., 1221 MCKINNEY STREET, HOUSTON, TX, 77010, US

(21) Appl. No.: 10/811,421

(22) Filed: Mar. 26, 2004

(30) Foreign Application Priority Data
Mar. 31, 2003 (JP) 2003-093737(P)

(51) Int. Cl. H04N 5/91

(52) U.S. Cl. 386/46

(57) ABSTRACT

Equipment for DVD includes a flash memory in which key data associated with information on a DVD is recorded in advance, and accesses the information on the DVD using the key data read from the flash memory. The key data is recorded in advance in a specific area of the flash memory, and random data is written in advance around the key data. The key data refers to an encryption key for equipment for encrypting and recording information on the DVD or a decryption key for equipment for decrypting the information read from the DVD. Such a key is recorded, buried in the random data.

### BACKGROUND OF THE INVENTION

1. Field of the Invention

The present invention relates to equipment for DVD (Digital Video Disc) giving protection against copy or theft of prescribed information recorded in a memory, and a method and an apparatus for recording the prescribed information. More particularly, the present invention relates to equipment for DVD capable of protecting prescribed information such as a password or key data for encryption or decryption recorded in a memory, and a method and an apparatus for recording the prescribed information. Here, the equipment for DVD refers to equipment accessing a DVD in order to reproduce information therefrom, or equipment accessing a DVD in order to record information thereon.

2. Description of the Background Art

Conventionally, as a technique to protect copyright, for example, Japanese Patent Laying-Open No. 2002-73420 and Japanese Patent Laying-Open No. 2002-16593 disclose technology for encryption and decryption using a key. According to Japanese Patent Laying-Open No. 2002-73420, an encryption key is used to encrypt data of which copyright should be protected. According to Japanese Patent Laying-Open No. 2002-16593, encryption processing is performed based on key information.

Recently, according to DVD specifications, CPPM (Content Protection for Prerecorded Media) and CPRM (Content Protection for Recordable Media) have been adopted as technology for protecting copyright (copy control technology). CPPM was developed for media for reproduction-only, whereas CPRM was developed for recordable media. In both of these schemes, copy control is achieved by recording a bunch of keys called MKB (Media Key Block) on a medium and using those keys together with a device key prepared (recorded) in equipment.

More specifically, contents that have already been recorded or will be recorded on a medium are encrypted in entirety. Accordingly, in reproduction, a “media key” required for decryption is generated using the device key prepared in advance in the equipment and the MKB recorded in the medium. With the media key, the contents are decrypted and reproduced. The MKB is distributed in advance to media manufacturers by a licenser, and the device key prepared in the equipment is also given in advance to equipment manufacturers from the licenser. The device key to be used is different from each other without exception, that is, the same key will not be used.

In the equipment for DVD, “key” information is stored in a specific area in an internal flash memory. As the flash memory is configured as rewritable by a prescribed unit, for example, a unit of 32 Kb, the “key” information of “25 bits” for example is stored in an area of the prescribed unit, that is, an area of 32 Kb. In this case, data of all “0” (or all “1”) is written in an area within the 32 Kb area except for where the “key” information has been stored (unused area). Therefore, if a flash memory alone is copied from outside, the “key” information tends to readily be distinguished, resulting in undesired copy or theft.

### SUMMARY OF THE INVENTION

An object of the present invention is to provide equipment for DVD capable of protecting prescribed information such as key data stored in a memory against copy or peeping, as well as a method and an apparatus for recording the prescribed information.

In order to achieve the above-described object, equipment for DVD according to one aspect of the present invention includes a memory in which key data associated with information on a DVD is recorded in advance, and a processing portion processing information on the DVD using the key data read from the memory. In the memory, random data is written around the key data.

As the key data is recorded buried in the random data in the memory, a third party cannot identify and read the key data from the memory. Therefore, the key data stored in the memory can be protected against copy or peeping.

Preferably, the key data described above is an encryption key for equipment for encrypting and recording information on a DVD. Therefore, in the equipment for DVD encrypting and recording the information on the DVD, the encryption key for equipment for encryption can be protected against copy or peeping.

Preferably, the key data described above is a decryption key for equipment for decrypting the information read from the DVD. Therefore, in the equipment for DVD decrypting and reproducing the information read from the DVD, the decryption key for equipment for decryption can be protected against copy or peeping.

According to yet another aspect of the present invention, a method of recording in advance prescribed information to be protected against unauthorized access in a memory includes the steps of writing the prescribed information in an unused area of the memory, and writing random data in an area within the unused area adjacent to the prescribed information written in the step of writing.

When the prescribed information is written in the memory, the random data is written in the area adjacent thereto. Therefore, the prescribed information is recorded, buried in the random data. Accordingly, the prescribed information stored in the memory can be protected against copy or peeping.

Preferably, the memory described above is mounted on the equipment for DVD, and the prescribed information is key data associated with information on the DVD. Therefore, the key data associated with the information on the DVD stored in the memory can be protected against copy or peeping.

Preferably, the prescribed information described above is a password. Therefore, the password stored in the memory can be protected against copy or peeping.

According to yet another aspect of the present invention, an apparatus for carrying out the method described above is provided.

According to yet another aspect of the present invention; a readable memory is provided. In this memory, prescribed information to be protected against unauthorized access and random data in an area adjacent to the prescribed information are at least written.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a configuration of equipment for DVD according to an embodiment of the present invention.

FIG. 2 illustrates an example of contents in a flash memory according to the embodiment of the present invention.

FIG. 3 illustrates a procedure for write processing of key data according to the embodiment of the present invention.

FIG. 4 illustrates a configuration of a microcomputer according to the embodiment of the present invention.

### DESCRIPTION OF THE PREFERRED EMBODIMENTS

In the following, an embodiment of the present invention will be described with reference to the figures.

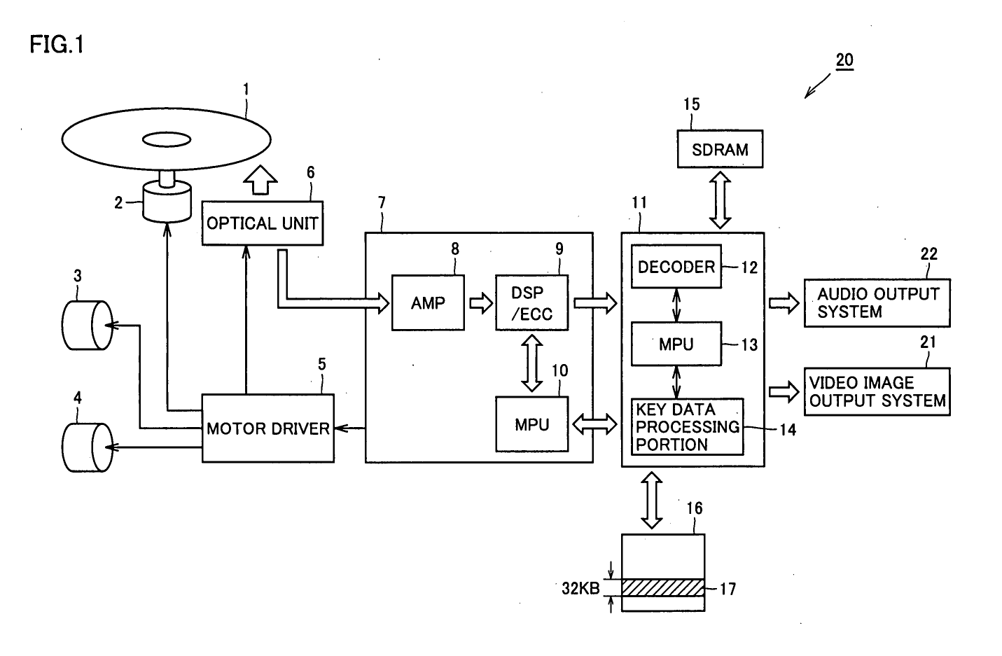

FIG. 1 shows a configuration of equipment for DVD 20. Equipment for DVD 20 includes a DVD 1 to be reproduced, a variety of motors 2, 3 and 4 driving DVD 1 for reproduction, a motor driver 5 for controlling these motors, an optical unit 6 for reading information from DVD 1, a front end 7 processing a data signal read from DVD 1 by optical unit 6, a back end 11 processing data processed by front end 7 such that the data can be output via a TV (television) set or the like, an SDRAM (Synchronous Dynamic Random Access Memory) 15 storing a program and data for processing in back end 11, and a flash memory 16.

Front end 7 includes an AMP (amplifier) 8 receiving and amplifying a reproduced signal, a DSP/ECC 9 subjecting the amplified signal to digital signal processing (DSP) and error correcting code (ECC), and an MPU (Micro Processing Unit) 10 controlling these components.

Back end 11 serves as a processing portion for reproduction processing of the information on DVD 1 using the key data read from flash memory 16. Back end 11 includes a decoder 12 receiving the digital signal output from DSP/ECC 9 and subjects the digital signal to decode processing, an MPU 13, and a key data processing portion 14 reading key data of a prescribed length from a prescribed address in flash memory 16 and processing the same, in order to obtain key data for decryption processing. Among the signals processed in back end 11, a video image signal is output to an image output system 21, whereas an audio signal is output to an audio output system 22. Decoder 12 performs decode processing using the key data obtained as a result of processing in key data processing portion 14.

Flash memory 16 is rewritable in a prescribed unit, for example, a unit of 32 Kb. In a specific area 17 of 32 Kb, key data is stored in advance in a unit of byte for decryption or the like.

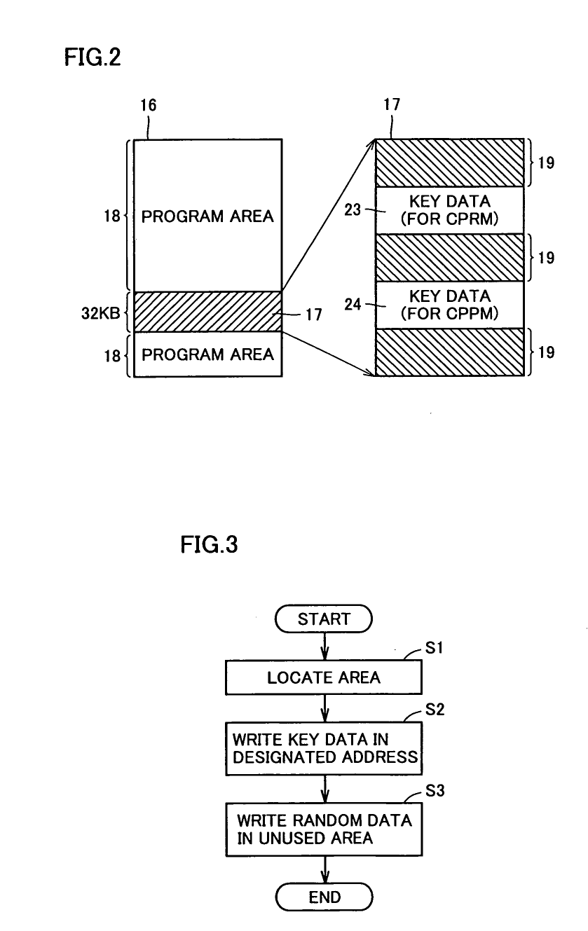

Referring to FIG. 2, flash memory 16 has an area 18 for a program and specific area 17. Specific area 17 stores key data, for example, key data 23 and 24 for CPRM and CPPM respectively. In specific area 17, random data which is not all “0” nor all “1” is also written in advance in an area 19 (area not used for the key data) adjacent to the area storing the key data. Therefore, as specific area 17 stores the key data in the random data area, a third party cannot identify and read out solely key data 23 and 24.

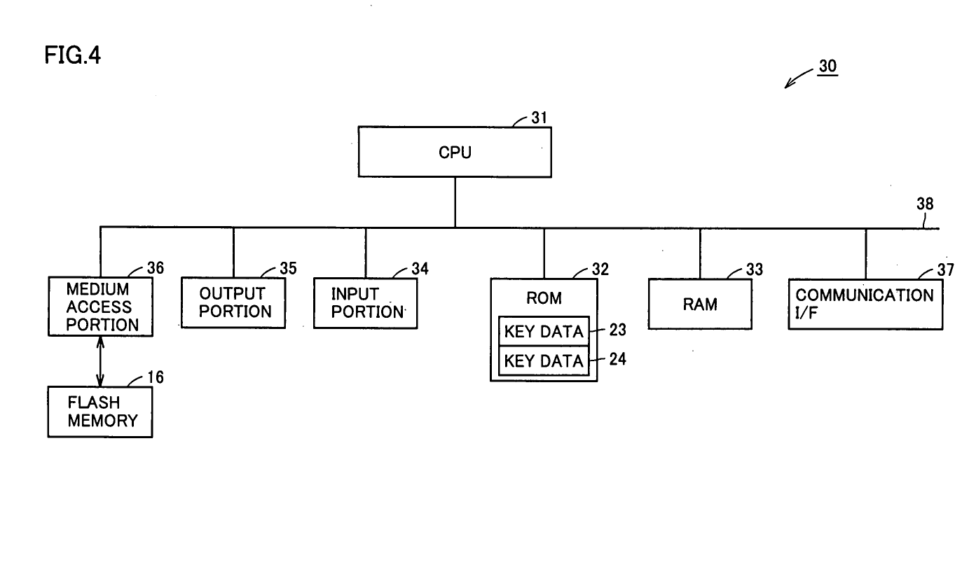

Flash memory 16 having key data 23 and 24 written as shown in FIG. 2 is mounted to equipment for DVD 20 during manufacture of equipment for DVD 20. At the time of attachment, a program has already been written in flash memory 16. When an unused, empty area where a program has not been written is rewritten with a not-shown personal computer or the like, key data 23 and 24 is written. Writing of key data 23 and 24 is performed by program-controlled key data writing equipment such as a personal computer 30 in FIG. 4.

Referring to FIG. 4, personal computer 30 includes a CPU (Central Processing Unit) 31, an ROM (Read Only Memory) 32 and an RAM (Random Access Memory) 33 for storing a program and data, an input portion 43 including externally operated keys for input of information in accordance with an operation, an output portion 35 attaining a function as display or printing so as to output information to the outside, a medium access portion 36, and a communication I/F (Inter Face) 37 for communication via an external network. These components are connected such that communication with each other can be established via a bus 38. CPU 31 controls each component via bus 38 in accordance with a program stored in ROM 32 or RAM 33. It is assumed that ROM 32 stores key data 23 and 24 in advance.

A variety of recording media including flash memory 16 are externally attached to medium access portion 36 in a detachable manner. Medium access portion 36 reads and writes information by accessing an attached recording medium under the control of CPU 16. After reading and writing of the information is completed, the recording medium is removed from medium access portion 36 and can be mounted to other equipment.

When flash memory 16 is used, medium access portion 36 cooperates with CPU 31 to serve as a writing portion of the key data as well as a writing portion of the random data. When data writing is completed, flash memory 16 is removed from medium access portion 36 and mounted to equipment for DVD 20 in FIG. 1.

A specific writing procedure using personal computer 30 serving as key data writing equipment will now be described with reference to FIG. 3.

Initially, flash memory 16 having a program written in advance in program area 18 is attached to medium access portion 36. Then, CPU 31 accesses flash memory 16, and locates specific area 17 for writing the key data in an area not used for program area 18 (step S1 (hereinafter, step is simply abbreviated as S)). CPU 31 reads key data 23 and 24 from ROM 32, and writes a data column of read key data 23 and 24 (in a unit of byte) in a prescribed address in specific area 17 (S2). Here, CPU 31 writes random data in unused area 19 within specific area 17 except for where key data 23 and 24 has been written (S3). Writing of key data 23 and 24 is completed in the above-described manner, and flash memory 16 having key data 23 and 24 written is removed from medium access portion 36 and in turn mounted to equipment for DVD 20.

In the present embodiment, the key data for decryption in flash memory 16, for example, key data 23 and 24 for reproduction in accordance with CPPM or CPRM has been assumed as data to be protected. The present invention, however, is not limited to such an example. For example, the key data for encryption in flash memory 16 applied to equipment for DVD for encrypting and recording information on DVD 1 may be protected. In addition, a password for access to an apparatus (system), a password for communication or the like may be protected, without limited to the key data for encryption/decryption.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. Equipment for a digital video disc, comprising:
a memory in which key data associated with information on a digital video disc is recorded in advance; and
means for processing the information on said digital video disc using said key data read from said memory; wherein
random data is written around said key data in said memory.

2. The equipment for a digital video disc according to claim 1, wherein
said key data is an encryption key for equipment for encrypting and recording the information on said digital video disc.

3. The equipment for a digital video disc according to claim 2, wherein
said key data is a decryption key for equipment for decrypting the information read from said digital video disc.

4. The equipment for a digital video disc according to claim 1, wherein
said key data is a decryption key for equipment for decrypting the information read from said digital video disc.

5. A method of recording in advance prescribed information to be protected against unauthorized access in a memory, comprising the steps of:
writing said prescribed information in an unused area of said memory; and
writing random data in an area within said unused area adjacent to said prescribed information written in said step of writing.

6. The method of recording prescribed information according to claim 5, wherein
said memory is mounted on equipment for a digital video disc, and
said prescribed information is key data associated with information on a digital video disc.

7. The method of recording prescribed information according to claim 5, wherein
said prescribed information is a password.

8. An apparatus for recording in advance prescribed information to be protected against unauthorized access in a memory, comprising:
means for writing said prescribed information in an unused area of said memory; and
means for writing random data in an area within said unused area adjacent to said prescribed information written in said step of writing.
